(19) United States
(12) Patent Application Publication
(10) Pub. No.: US 2022/0333045 A1
(43) Pub. Date: Oct. 20, 2022

(54) PROCESS FOR MAKING WATER-SOLUBLE UNIT DOSE ARTICLES

(71) Applicant: The Procter & Gamble Company, Cincinnati, OH (US)

(72) Inventors: Timothy BULLIVANT, Newcastle upon Tyne (GB); Nicholas Alexander Jesse McGUCKIN, Newcastle upon Tyne (GB); Helen Amy LANG, Newcastle upon Tyne (GB); Eric San Jose ROBLES, Newcastle upon Tyne (GB); Hossam Hassan TANTAWY, Morpetht (GB)

(21) Appl. No.: 17/855,125

(22) Filed: Jun. 30, 2022

Related U.S. Application Data
(63) Continuation of application No. PCT/US2021/035099, filed on Jun. 1, 2021.

(30) Foreign Application Priority Data
Jun. 1, 2020 (EP) 20177723.2

(51) Int. Cl. C11D 17/04; D04H 1/4309

(52) U.S. Cl. CPC C11D 17/042; D04H 1/4309

(57) ABSTRACT

A process of making a water-soluble unit dose article in which the process does not include a thermoforming step.

### FIELD OF THE INVENTION

A process of making a water-soluble unit dose article.

### BACKGROUND OF THE INVENTION

Water-soluble unit dose articles are liked by consumers due to their convenience and ease of use. Without wishing to be bound by theory, water-soluble unit dose articles comprise a water-soluble wrapping shaped to form at least one internal compartment which houses a single use dose of a detergent. Upon addition of the water-soluble unit dose article to water, the water-soluble wrapping dissolves and/or disintegrates releasing the detergent into the surrounding water to produce a wash liquor.

Current known on-market water-soluble unit dose articles are made from water-soluble polyvinyl alcohol sheets using a cavity mould process. Such processes comprise the steps of thermoforming and/or vacuum forming the sheet into a mould to create a cavity, filling the cavity Cavity mould processes are known from EP2258820A and WO0240351. However, there is a desire to make unitized detergent articles without the need for a cavity mould process.

Therefore, there is a need to provide a process for making a water-soluble unit dose article in which the process does not involve a cavity moulding step. The process needs to be efficient and effective with ability and preferably be efficient and effective under a wide range of climatic conditions, for example high temperature and/or humidity.

It was surprisingly found that the process according to the present invention addressed this problem.

### SUMMARY OF THE INVENTION

An aspect of the present invention is a process of making a water-soluble detergent unit dose article comprising the steps of
a. providing a water-soluble non-woven fibrous sheet on a roll;
b. unwinding the water-soluble non-woven fibrous sheet in a machine direction from the roll via at least a first intermediate roll;
c. feeding the water-soluble non-woven fibrous sheet from the at least one intermediate roll via a forming unit to shape the water-soluble non-woven fibrous sheet into a tube shape;
d. sealing the water-soluble non-woven fibrous sheet via a machine direction seal, a cross-direction seal or a mixture thereof to create a container having an open end;
e. filling the open container with a water-soluble granular detergent composition;
f. sealing the second open end via a machine direction seal, a cross-direction seal or a mixture thereof to form a closed water-soluble unit dose article;
g. transferring the water-soluble unit dose article onto a moving conveyer;
h. transporting the water-soluble unit dose article from the moving conveyer into a packaging container.

### BRIEF DESCRIPTION OF THE DRAWINGS

FIG. 1 depicts a process according to the present invention.

FIG. 2 depicts a forming unit according to the present invention.

### DETAILED DESCRIPTION OF THE INVENTION

Process of Making a Water-Soluble Detergent Unit Dose Article

The present invention relates to a process of making a water-soluble detergent unit dose article. Without wishing to be bound by theory, a water-soluble unit dose article is a detergent composition wrapped in a water-soluble sheet. When added to water, the water-soluble sheet dissolves/disintegrates releasing the detergent into the water to create a wash liquor. There is sufficient detergent composition present for a single wash operation.

Without wishing to be bound by theory, the present invention provides a process for making a water-soluble unit dose article with a water-soluble fibrous non-woven sheet. It is the specific steps in the present process, including the step of selecting a water-soluble fibrous non-woven sheet that overcame the problem addressed by the present invention.

Without wishing to be bound by theory, the present invention provides the advantage that the unit dose article can be made from a single water-soluble sheet, which reduces the complexity of a cavity mould process in which two sheets must be used. Additionally, there is no step in which the water-soluble sheet is thermoformed and/or vacuum formed into a mould.

However, it was found that it is the specific combination of using a water-soluble fibrous non-woven sheet in combination with the steps of the process that overcame the problem.

Without wishing to be bound by theory, it was surprisingly if the specific sheet material according to the present invention is not selected, there is a tendency for the water-soluble sheet to stick to the intermediate rollers and/or forming unit during manufacture. This results in misalignment and bunching of the sheet resulting in misaligned seals. Such misaligned seals can result in failures in the seals and premature rupture of the unit dose article. Also, it means that the process needs to be run at a lower speed in order to reduce instances of sticking and/or bunching of the sheet.

Further to this, during manufacture, there is the potential for the water-soluble sheet to ‘slip’ from the roll during unwinding. This means the water-soluble sheet is misaligned at the point it leaves the film roll and passes via any intermediate rolls. To overcome the issue, the unwinding needs to be constantly corrected and the process run at lower overall line speeds.

In addition, there is a tendency for the sheet to shrink during the manufacturing process. Such sheet shrinkage means that fewer unit dose articles can be made from a single roll. This is inefficient and wasteful in terms of sheet usage.

Furthermore, once the unit dose article is made, they are transported along a conveyer and packed in a container. There could be a tendency for the unit dose articles to stick on the conveyer and in the container. This can result in blockages on the conveyer and inaccurate filling of the container. One solution is to coat the unit dose articles with a lubricating coating. However, this is inefficient and resource intensive as the lubricating layer does not provide any cleaning performance benefit for the unit dose article. This is an additional benefit of the present invention in which the amount of lubricating layer can be reduced or eliminated.

Without wishing to be bound by theory, the above issues are exacerbated at higher temperatures and humidities. It was surprisingly found that the process of the present invention allowed for water-soluble unit dose articles to made under a range of temperatures and humidities.

Without wishing to be bound by theory, the steps of the present process are operated using a suitable apparatus. Those skilled in the art will be aware of suitable apparatus.

The process of the present invention comprises the step of;
a. providing a water-soluble non-woven fibrous sheet on a roll.

The water-soluble non-woven fibrous sheet is described in more detail below. The water-soluble fibrous non-woven is provided on a roll. The roll can have any suitable width or diameter. Preferably, the roll has a width of between 90 mm and 350 mm, preferably between 100 mm and 300 mm Preferably, the roll has a diameter of between 200 mm and 700 mm, preferably between 300 mm and 600 mm.

The process of the present invention comprises the step of;
b. unwinding the water-soluble non-woven fibrous sheet in a machine direction from the roll via at least a first intermediate roller.

The roll is unwound in a machine direction. By ‘machine direction’, we herein mean the direction of motion of the water-soluble fibrous non-woven sheet through the apparatus used to perform the steps of the present invention. By ‘cross-direction’ we herein mean the direction 90° relative to the machine direction.

The water-soluble fibrous non-woven sheet may be unwound manually or may be unwound using motorized assistance or a mixture thereof. Those skilled in the art will be aware of suitable motorised assistance means.

The water-soluble fibrous non-woven sheet is unwound by at least a first intermediate roller. Those skilled in the art will be aware of suitable intermediate rollers. Suitable intermediate rollers can include tension arms, a transfer roller or a mixture thereof. The water-soluble fibrous non-woven sheet is unwound by at least a first intermediate roller. Those skilled in the art will be aware of suitable intermediate rollers. Preferably, the water-soluble fibrous non-woven sheet passes over a dancer arm which is a weighted pivot arm. The arm incorporates a series of rollers. As the non-woven sheet transports, the arm moves up and down to keep the non-woven sheet under tension. This is necessary so the non-woven sheet does not travel from side to side as it passes through the apparatus. The tension art may be constructed from any suitable material. The transfer roller may be constructed from any suitable material. Those skilled in the art will be aware that transfer rollers may be purchased as Hard Chrome Plated Rollers, Industrial Aluminum Rollers and Teflon Coated Rollers. Other rollers types also exist.

The process of the present invention comprises the step of;
c. feeding the water-soluble non-woven fibrous sheet from the at least one intermediate roll via a forming unit to shape the water-soluble non-woven fibrous sheet into a tube shape.

Without wishing to be bound by theory, the forming unit shapes the water-soluble non-woven fibrous sheet into a tube shape. The tube shape comprises a first open end and a second open end. Without wishing to be bound by theory, the first open end is opposite to the second open end in a machine direction.

Without wishing to be bound by theory, the non-woven fibrous sheet has a first edge and a second edge, and the first edge and second edge are brought into proximity of one another to create the tube shape.

Preferably, the forming unit comprises a forming tube. Preferably, the non-woven fibrous sheet has a first edge and a second edge, and as the non-woven fibrous sheet passes over the forming tube the first edge and second edge are brought into proximity of one another. The first edge and second edge may overlap one another. Without wishing to be bound by theory, the first edge is opposite to the second edge in a cross-direction.

Those skilled in the art will be aware of any suitable shape for the forming tube. The forming tube may be constructed from any suitable material. The forming tube may be made from stainless steel. The forming tube may be pattern rolled and polished. The forming tube may comprise a range of coating options to help reduce film drag, reduce blockages and reduce noise. The coatings are designed to reduce friction and sheet drag in the forming unit.

The forming tube may form the tube in a vertical orientation, a horizontal orientation or a diagonal orientation. Preferably, the forming tube is hollow. Without wishing to be bound by theory, a hallow forming tube aids in filling of the water-soluble unit dose article.

Preferably, the forming unit comprises a forming shoulder. Without wishing to be bound by theory, the water-soluble non-woven sheet firstly crests the shoulder ahead of the forming tube, and it is folded around the tube so that the result is a tube of non-woven sheet with the two outer edges of the non-woven sheet overlapping each other.

Those skilled in the art will be aware of any suitable shape for the forming shoulder. The forming shoulder may be constructed from any suitable material. The forming shoulder may be made from stainless steel. The forming shoulder may be pattern rolled and polished. The forming shoulder may comprise a range of coating options to help reduce film drag, reduce blockages and reduce noise.

The forming tube can be set up to make a lap seal or fin seal. A lap seal overlaps the two outer edges of the non-woven sheet to create a flat seal, while a fin seal marries the insides of the two outer edge of the non-woven sheet to create a seal that sticks out, like a fin. A lap seal is generally considered more aesthetically pleasing and uses less material than a fin seal.

Preferably, the forming unit comprises belts to pull the non-woven fibrous sheet in a machine direction during forming of the tube. Those skilled in the art will be aware of suitable belts. The non-woven fibrous sheet is preferably drawn down by two gear motors which drive friction pull-down belts located on either side of the forming tube. Pull down belts that utilize vacuum suction to grip the non-woven sheet can be suitable alternatives to friction belts if there is a desire to reduce slip between the non-woven sheet and belt.

The process of the present invention comprises the step of;
d. sealing the water-soluble non-woven fibrous sheet via a machine direction seal, a cross-direction seal or a mixture thereof to create a container having an open end.

Without wishing to be bound by theory, a container with an open end is made, ready for filling with the detergent composition. Preferably, the open end is positioned to allow for horizontal filling of the open container in next step e. Alternatively, the open end may be positioned to allow for vertical filling of the open container in next step e. Alternatively, the open end may be positioned to allow for diagonal filling of the open container in next step e.

A machine direction seal is a seal which runs in the machine direction. A cross-direction seal is a seal in the cross-direction.

The open container may be made by folding the water-soluble non-woven fibrous sheet to create the open tube, then creating a machine direction seal to create the open container wherein the open container is orientated to be filled horizontally. Alternatively, the open container made be made by folding the water-soluble non-woven fibrous sheet to create the open tube, then creating a first cross-direction seal followed by a second cross-direction seal to create the open container wherein the open container is orientated to be filled horizontally.

Each machine direction seal may be independently sealed via heat sealing, solvent sealing, pressure sealing, ultrasonic sealing or a mixture thereof, preferably heat sealing. The machine direction seals may be achieved using a machine direction sealing unit, wherein the machine direction sealing unit can be a static seal unit or a reciprocating seal unit. Those skilled in the art will be aware of suitable sealing units.

Without wishing to be bound by theory, when the water-soluble non-woven fibrous sheet is sealed using a static machine direction sealing unit, the first edge and second edge of the water-soluble non-woven fibrous sheet are sealed together as they continuously pass through the static sealing unit. Those skilled in the art will be aware of suitable static sealing units. Preferably the static sealing unit comprises a first heating element and a second heating element, wherein the heating elements are position opposite to one another. As the first edge and second edge of the water-soluble non-woven fibrous sheet pass between the first heating element and the second heating element they are sealed together. The first edge and second edge of the water-soluble non-woven fibrous sheet may be sealed in a machine direction such that the sealed edges create a lip that extends from the water-soluble unit dose article. The first and second heating elements may apply a pressure on the first edge and the second edge of the water-soluble non-woven fibrous sheet during the heat sealing. Without wishing to be bound by theory, the application of pressure provides an improved seal between the first edge and second edge.

Without wishing to be bound by theory, when the water-soluble non-woven fibrous sheet is sealed using a reciprocating machine direction sealing unit, the first edge and second edge of the water-soluble non-woven fibrous sheet are sealed together in a stop/start sealing operation. The reciprocating sealing unit seals a portion of the first edge and second edge whilst simultaneously moving in a machine direction. Following sealing the sealing unit moves back to a starting position and seals the next portion of the first edge and second edge. Preferably, the reciprocating sealing unit comprises a first heating element and a second heating element. The first and second heating elements may apply a pressure on the first edge and the second edge of the water-soluble non-woven fibrous sheet during the heat sealing. Without wishing to be bound by theory, the application of pressure provides an improved seal between the first edge and second edge.

Each cross-direction may be independently sealed via heat sealing, solvent sealing, pressure sealing, ultrasonic sealing or a mixture thereof, preferably heat sealing.

Without wishing to be bound by theory, when the water-soluble non-woven fibrous sheet is sealed using a static cross-direction sealing unit, the water-soluble non-woven fibrous sheet is sealed as it continuously passes through the static sealing unit. Those skilled in the art will be aware of suitable static sealing units. Preferably the static sealing unit comprises a first heating element and a second heating element, wherein the heating elements are position opposite to one another. As the water-soluble non-woven fibrous sheet pass between the first heating element and the second heating element the two sides are sealed together. The first and second heating elements may apply a pressure on the water-soluble non-woven fibrous sheet during the heat sealing. Without wishing to be bound by theory, the application of pressure provides an improved seal.

Without wishing to be bound by theory, when the water-soluble non-woven fibrous sheet is sealed using a reciprocating cross-direction sealing unit, the two sides of the water-soluble non-woven fibrous sheet are sealed together in a stop/start sealing operation. The reciprocating sealing unit seals a portion of the two sides of the water-soluble fibrous non-woven sheet together whilst simultaneously moving in a machine direction. Following sealing the sealing unit moves back to a starting position and seals the next portion of the water-soluble fibrous non-woven sheet. Preferably, the reciprocating sealing unit comprises a first heating element and a second heating element. The first and second heating elements may apply a pressure on the water-soluble non-woven fibrous sheet during the heat sealing. Without wishing to be bound by theory, the application of pressure provides an improved seal.

The process of the present invention comprises the step of;
e. filling the open container with a water-soluble granular detergent composition.

The water-soluble granular detergent composition is described in more detail below. Those skilled in the art will be aware of suitable filling units to fill the open container with the water-soluble granular detergent composition. The filling unit may be an auger. Alternatively, the filling unit may be a multi-head scale. Preferably, the filling unit fills a pre-determined portion of the water-soluble granular detergent composition into the open container. Those skilled in the art will be aware of suitable means.

Preferably, the water-soluble granular detergent composition is dropped down the middle of the hollow forming tube and filled into the open container.

The process of the present invention comprises the step of;
f. sealing the second open end via a machine direction seal, a cross-direction seal or a mixture thereof to form a closed water-soluble unit dose article.

Without wishing to be bound by theory, the filled open container is now sealed closed to create the water-soluble unit dose article.

Each machine direction seal may be independently sealed via heat sealing, solvent sealing, pressure sealing, ultrasonic sealing or a mixture thereof, preferably heat sealing. The machine direction seals may be achieved using a machine direction sealing unit, wherein the machine direction sealing unit can be a static seal unit or a reciprocating seal unit. Those skilled in the art will be aware of suitable sealing units.

Without wishing to be bound by theory, when the open filled container is sealed using a static machine direction sealing unit, the first edge and second edge of the water-soluble non-woven fibrous sheet are sealed together as they continuously pass through the static sealing unit. Those skilled in the art will be aware of suitable static sealing units. Preferably the static sealing unit comprises a first heating element and a second heating element, wherein the heating elements are position opposite to one another. As the first edge and second edge of the water-soluble non-woven fibrous sheet pass between the first heating element and the second heating element they are sealed together. The first edge and second edge of the water-soluble non-woven fibrous sheet may be sealed in a machine direction such that the sealed edges create a lip that extends from the water-soluble unit dose article. The first and second heating elements may apply a pressure on the first edge and the second edge of the water-soluble non-woven fibrous sheet during the heat sealing. Without wishing to be bound by theory, the application of pressure provides an improved seal between the first edge and second edge.

Without wishing to be bound by theory, when the filled open container is sealed using a reciprocating machine direction sealing unit, the first edge and second edge of the water-soluble non-woven fibrous sheet are sealed together in a stop/start sealing operation. The reciprocating sealing unit seals a portion of the first edge and second edge whilst simultaneously moving in a machine direction. Following sealing the sealing unit moves back to a starting position and seals the next portion of the first edge and second edge. Preferably, the reciprocating sealing unit comprises a first heating element and a second heating element. The first and second heating elements may apply a pressure on the first edge and the second edge of the water-soluble non-woven fibrous sheet during the heat sealing. Without wishing to be bound by theory, the application of pressure provides an improved seal between the first edge and second edge.

Each cross-direction may be independently sealed via heat sealing, solvent sealing, pressure sealing, ultrasonic sealing or a mixture thereof, preferably heat sealing.

Without wishing to be bound by theory, when the filled open container is sealed using a static cross-direction sealing unit, the two sides of the water-soluble non-woven fibrous sheet are sealed together as they continuously pass through the static sealing unit. Those skilled in the art will be aware of suitable static sealing units. Preferably the static sealing unit comprises a first heating element and a second heating element, wherein the heating elements are position opposite to one another. As the water-soluble non-woven fibrous sheet pass between the first heating element and the second heating element the two sides are sealed together. The first and second heating elements may apply a pressure on the water-soluble non-woven fibrous sheet during the heat sealing. Without wishing to be bound by theory, the application of pressure provides an improved seal.

Without wishing to be bound by theory, when the filled open container is sealed using a reciprocating cross-direction sealing unit, the two sides of the water-soluble non-woven fibrous sheet are sealed together in a stop/start sealing operation. The reciprocating sealing unit seals a portion of the two sides of the water-soluble fibrous non-woven sheet together whilst simultaneously moving in a machine direction. Following sealing the sealing unit moves back to a starting position and seals the next portion of the water-soluble fibrous non-woven sheet. Preferably, the reciprocating sealing unit comprises a first heating element and a second heating element. The first and second heating elements may apply a pressure on the water-soluble non-woven fibrous sheet during the heat sealing. Without wishing to be bound by theory, the application of pressure provides an improved seal.
g. transferring the water-soluble unit dose article onto a moving conveyer.

Preferably the closed water-soluble unit dose article is separated from the adjacent filled open container or closed water-soluble unit dose article. Without wishing to be bound by theory, a first water-soluble unit dose article may be created and separated before the next water-soluble unit dose article is made. Alternatively, a first water-soluble unit dose article may be created, followed by a second water-soluble unit dose article and then the two water-soluble unit dose articles separated.

Those skilled in the art will be aware of suitable means to separate the water-soluble unit dose article from the adjacent filled open container or water-soluble unit dose article. The water-soluble unit dose article may be separated using a knife. The knife may be a static knife or a rotating knife.

Preferably the water-soluble unit dose article drops on the conveyer under the influence of gravity. Alternatively, the water-soluble unit dose article is manually transferred, mechanically transferred or a mixture thereof to the conveyer.
h. transporting the water-soluble unit dose article from the moving conveyer into a packaging container.

Preferably, the conveyer is a continuously moving surface. Those skilled in the art will be aware of suitable conveyor designs to transport the water-soluble unit dose articles in the relevant direction.

Preferably, the conveyer comprises a means to transfer a determined plurality of water-soluble unit dose articles to the container. Preferably, the water-soluble unit dose articles enter into a counting unit that is capable of sorting a prescribed number of water-soluble unit dose articles that are subsequently transferred to the packaging container. Those skilled in the art will be aware of suitable counting technologies that are preferably based on weight, visualization analysis software or a mixture thereof.

Those skilled in the art will be aware of suitable packaging containers. The packaging container may be a packaging container suitable for shipping and selling the water-soluble unit dose articles to consumers. Alternatively, the packaging container may be an intermediate storage container intended to store the water-soluble unit dose articles before they are redistributed into alternative packaging containers for shipping and selling to consumers.

The packaging container can be made from plastic, metal, paper-based material or a mixture thereof.

Preferably, the environmental conditions from step d onwards are a temperature of between 20° C. and 30° C. and a relative humidity of between 50% and 95%, and wherein ‘environmental conditions’ mean the conditions immediately surrounding the water-soluble unit dose article. Without wishing to be bound by theory, the issues of film sticking, misalignment and shrinking are exacerbated at higher temperatures and relative humidities. The process of the present was found to be efficient in a range of temperatures and humidites. This results in reduce resources needed as tight control of the temperature and humidity is not as necessary as for known methods of making water-soluble unit dose articles.

Preferably, no lubricating coating is applied to the exterior surface of the unit dose article, preferably wherein the lubricating coating is selected from silica, talc, zeolite or a micture thereof. Without wishing to be bound by theory, the present invention overcomes the issue of sticking of the unit dose articles during transport and packing without the need to apply a lubricating coating to the exterior surface of the unit dose articles. It is believed that the porous nature of the water-soluble fibrous non-woven sheet means that some of the water-soluble granular detergent is transferred to the surface of the water-soluble unit dose article. This has the advantage that a separate lubricating coating is not needed which results in less intensity on resources and a more efficient process.

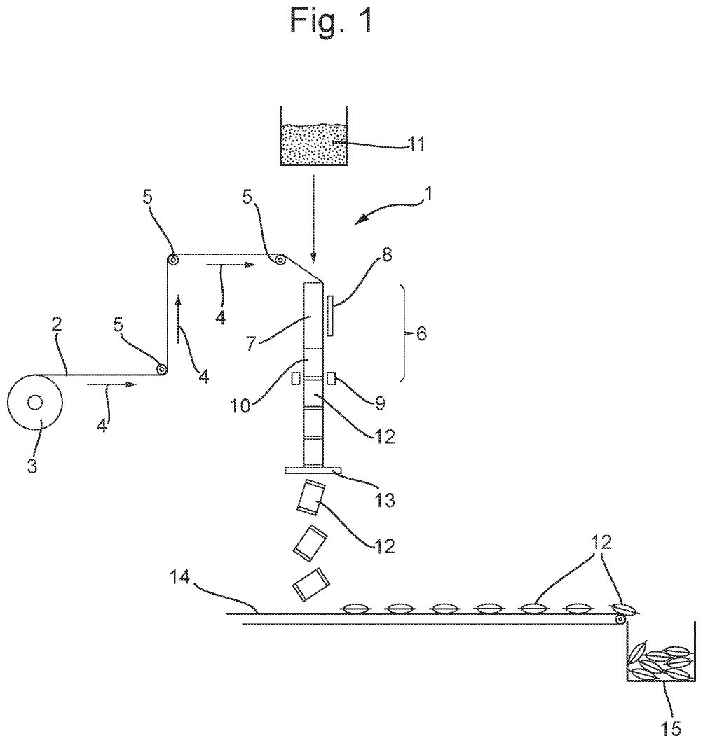

FIG. 1 details an exemplary process (1) according to the present invention. The process (1) comprises the steps of;
a. providing a water-soluble non-woven fibrous sheet (2) on a roll (3);
b. unwinding the water-soluble non-woven fibrous sheet (2) in a machine direction (4) from the roll (3) via at least a first intermediate roll (5);
c. feeding the water-soluble non-woven fibrous sheet (2) from the at least one intermediate roll (5) via a forming unit (6) to shape the water-soluble non-woven fibrous sheet (2) into a tube shape (7);
d. sealing the water-soluble non-woven fibrous sheet (3) via a machine direction seal (8), a cross-direction seal (9) or a mixture thereof to create a container having an open end (10);
e. filling the open container (10) with a water-soluble granular detergent composition (11);
f. sealing the second open end via a machine direction seal (8), a cross-direction seal (9) or a mixture thereof to form a closed water-soluble unit dose article (12) and cutting (13) the water-soluble unit dose article (12) from the next adjacent water-soluble unit dose article;
g. transferring the water-soluble unit dose article (12) onto a moving conveyer (14);
h. transporting the water-soluble unit dose article (12) from the moving conveyer (14) into a packaging container (15).

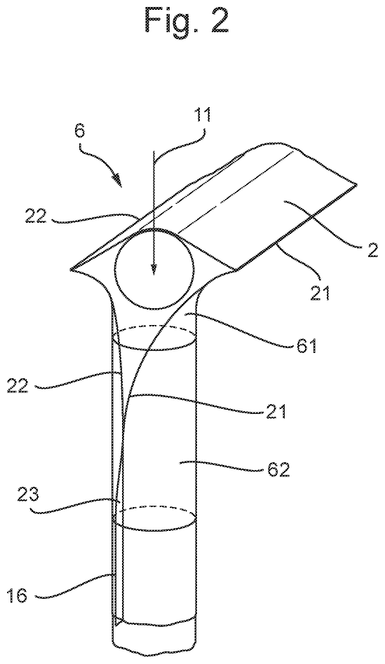

FIG. 2 depicts a forming unit (6) according to the present invention, comprising a forming shoulder (61) and a forming tube (62). The forming tube (62) is hallow to allow the water-soluble granular detergent composition (11) to flow into the open container (10). Once the water-soluble non-woven fibrous sheet (2) crests the forming shoulder (61) it folded around the tube (62) so that a first outer edge (21) of the non-woven sheet and a second outer edge (22) overlapping each other. These two edges are then sealed together (not shown) to create a machine direction seal (23).

The water-soluble fibrous non-woven sheet comprises a plurality of fibres. Preferably, the fibres are inter-entangled fibres in the form of a fibrous structure.

The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 15 gsm and 60 gsm, preferably between 20 gsm and 55 gsm, more preferably between 25 gsm and 50 gsm, most preferably between 30 gsm and 45 gsm. Those skilled in the art will be aware of methods to measure the basis weight.

Basis weight of a water-soluble fibrous non-woven sheet may be measured on stacks of twelve usable units using a top loading analytical balance with a resolution of ±0.001 g. The balance is protected from air drafts and other disturbances using a draft shield. A precision cutting die, measuring 8.9 cm±0.009 cm by 8.9 cm±0.009 cm is used to prepare all samples.

With a precision cutting die, cut the samples into squares. Combine the cut squares to form a stack where the stack is twelve samples thick. Measure the mass of the sample stack and record the result to the nearest 0.001 g.

The Basis Weight is calculated in g/m² (gsm) as follows:

Basis Weight=(Mass of stack)/[(Area of 1 square in stack)×(No.of squares in stack)]

By ‘fibre’ we herein mean an elongated element having a length exceeding its average diameter, preferably, a length to average diameter ratio of at least about 10.

Preferably, each fibre may have a length of greater than or equal to 5.08 cm, greater than or equal to 7.62 cm, greater than or equal to 10.16, greater than or equal to 15.24 cm or a mixture thereof.

Alternatively, each fibre may have length of less than 5.08 cm, less than 3.81 cm, less than 2.54 cm, or a mixture thereof.

Each fibre may have a width of less than 100 μm, less than 75 μm, less than 50 μm, less than 25 μm, less than 10 μm, less than 5 μm, less than 1 μm or a mixture thereof. Those skilled in the art will be aware of standard methods and techniques to measure the width. Preferred methods include Scanning Electron Microscope (SEM) or an Optical Microscope together with image analysis software.

The water-soluble fibrous non-woven sheet may comprise a plurality of identical or substantially identical, from a compositional perspective, fibres. Alternatively, the water-soluble fibrous non-woven sheet may comprise two or more different fibres according to the present invention. Non-limiting examples of differences in the fibres may be physical differences such as differences in diameter, length, texture, shape, rigidness, elasticity, and the like; chemical differences such as crosslinking level, solubility, melting point, Tg, active agent.

Preferably, the fibres are present between 85% and 100%, preferably between 90% and 100% by weight of the water-soluble fibrous non-woven sheet. Alternatively, the fibres are present between 90% and 99.75%, preferably between 95% and 99.5%, more preferably between 97% and 99% by weight of the water-soluble fibrous non-woven sheet.

The water-soluble fibrous non-woven sheet may exhibit different regions, such as different regions of basis weight, density, and/or caliper. The water-soluble fibrous non-woven sheet may comprise texture on one or more of its surfaces. A surface of the water-soluble fibrous non-woven sheet may comprise a pattern, such as a non-random, repeating pattern.

The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm Those skilled in the art will be aware of standard methods to measure the thickness.

The fibres comprise polyvinyl alcohol polymer. Preferably, the fibres comprises between 50% and 98%, preferably between 65% and 97%, more preferably between 80% and 96%, even more preferably between 88% and 96% by weight of the fibre of polyvinyl alcohol.

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 65 mPas, preferably from 5 to 60 mPas, most preferably from 10 to 55 mPas, wherein the viscosity is measured as a 4% aqueous solution in demineralized water at 20° C.

Preferably, the fibres comprise between 0.1% and 15% by weight of the fibres of a gel-breaker, wherein the gel-breaker is selected from polyols, sugar alcohols, amines, amides, carbohydrates, multivalent cations, or a mixture thereof, preferably polyols, sugar alcohols or a mixture thereof. Preferably, the fibres comprise between 1% and 12%, preferably between 2% and 10% by weight of the fibres of the gel-breaker.

Without wishing to be bound by theory, polyols are synthetic materials, whilst sugar alcohols are natural materials. Sugar alcohols may comprises ribose, xylose, fructose of a mixture thereof.

Preferably, the gel-breaker is selected from glycerol, polyethylene glycol, 1,2-propanediol, dipropylene glycol, 2-methyl-1,3-propanediol, trimethylpropanol, triethylene glycol, polyethylene glycol, sorbitol, cyclohexanedimethanol, hexylene glycol, dipropylene glycol n-butyl ether, 2-Methyl-2,4-pentanediol, polypropyleneglycol, urea, formamide, ethanolamine, carbohydrates, dianhydrohexitol, Magnesium chloride, sodium chloride, and mixtures thereof, preferably selected from polyethylene glycol, glycerol, sorbitol, trimethylpropanol, dipropylene glycol, and mixtures thereof.

Preferably, the fibres comprise between 0.1% and 15%, preferably between 1% and 12%, more preferably between 2% and 10% by weight of the fibres of a gel-breaker selected from glycerol, polyethylene glycol, 1,2-propanediol, dipropylene glycol, 2-methyl-1,3-propanediol, trimethylpropanol, triethylene glycol, polyethylene glycol, sorbitol, cyclohexanedimethanol, hexylene glycol, dipropylene glycol n-butyl ether, 2-Methyl-2,4-pentanediol, polypropyleneglycol, urea, formamide, ethanolamine, carbohydrates, dianhydrohexitol, Magnesium chloride, sodium chloride, and mixtures thereof, preferably, the fibres comprise between 0.1% and 15%, preferably between 1% and 12%, more preferably between 2% and 10% by weight of the fibres of a gel-breaker selected from polyethylene glycol, glycerol, sorbitol, trimethylpropanol, dipropylene glycol, and mixtures thereof.

Preferably, the fibres comprise between 0.1% and 15%, preferably between 1% and 12%, more preferably between 2% and 10% by weight of the fibres of the gel-breaker and wherein the fibres comprise between 0.1% and 15%, preferably between 1% and 12%, more preferably between 2% and 10% by weight of the fibres of a gel-breaker selected from glycerol, polyethylene glycol, 1,2-propanediol, dipropylene glycol, 2-methyl-1,3-propanediol, trimethylpropanol, triethylene glycol, polyethylene glycol, sorbitol, cyclohexanedimethanol, hexylene glycol, dipropylene glycol n-butyl ether, 2-Methyl-2,4-pentanediol, polypropyleneglycol, urea, formamide, ethanolamine, carbohydrates, dianhydrohexitol, Magnesium chloride, sodium chloride, and mixtures thereof. Preferably, the fibres comprise between 0.1% and 15%, preferably between 1% and 12%, more preferably between 2% and 10% by weight of the fibres of the gel-breaker and wherein the fibres comprise between 0.1% and 15%, preferably between 1% and 12%, more preferably between 2% and 10% by weight of the fibres of a gel-breaker selected from polyethylene glycol, glycerol, sorbitol, trimethylpropanol, dipropylene glycol, and mixtures thereof.

Preferably, the polyethylene glycol has a molecular weight of between 100 and 800, preferably between 200 and 750, more preferably between 400 and 700, even more preferably between 500 and 650.

The fibrous non-woven sheet may comprise a second plurality of particles. Without wishing to be bound by theory, the fibrous non-woven sheet comprises gaps or space between the fibres. When present, the second plurality of particles are present, they preferably reside within the gaps/spaces between the fibres. Preferably, the second plurality of particles are present between 0.25% and 10%, preferably between 0.5% and 5%, more preferably between 1% and 3% by weight of the water-soluble fibrous non-woven sheet. Preferably, the fibres are present between 85% and 100%, preferably between 90% and 100% by weight of the water-soluble fibrous non-woven sheet. Alternatively, the fibres are present between 90% and 99.75%, preferably between 95% and 99.5%, more preferably between 97% and 99% by weight of the water-soluble fibrous non-woven sheet. Those skilled in the art will be aware of methods to determine the weight percentage of the second plurality of particles. A preferred method involves the following steps; both sides of the fibrous non-woven sheet are carefully separated from a detergent filled unit dose article. Each side is separately weighed. Initial weight (ladened with particle) is recorded. The particle laden fabric is placed on a sieve and a dry air compressed line is blown through the fibrous non-woven sheet to remove all lodged particles. The weight of the fibrous nonwoven is remeasured to obtain the difference. The weight difference is recorded as ((initial weight−final weight)/initial weight)×100 (recorded as weight percentage).

Preferably, the second plurality of particles comprise zeolite, inorganic salts, surfactant granules or a mixture thereof. Preferably, the inorganic salts comprise sodium carbonate, sodium chloride, sodium sulphate or a mixture thereof. Preferably, the surfactant granules may comprise spray dried surfactant granules, agglomerated surfactant granules or a mixture thereof.

Preferably the second plurality of particles have an average particle size distribution of between 1 micron and 150 microns, preferably between 5 microns and 125 microns, more preferably between 10 microns and 100 microns.

Preferably, the fibres comprise less than 5%, more preferably less than 3%, even more preferably less than 2% by weight of the fibres of water.

The fibres may be made by any suitable process. The fibres may be spun from a filament-forming composition using techniques known to those in the art. Suitable spinning process operations may include meltblowing, spunbonding, electro-spinning, rotary spinning or mixtures thereof.

A non-limiting example of a suitable process for making the fibres comprises the steps of:
a. providing a filament-forming composition, such as from a tank; and
b. spinning the filament-forming composition, such as via a spinning die, into one or more fibres; and
c. collecting the fibres onto a collection device, such as a patterned belt.

The filament-forming composition may be transported via suitable piping, with or without a pump, between the tank and the spinning die. The spinning die may comprise a plurality of fibre-forming holes that include a melt capillary encircled by a concentric attenuation fluid hole through which a fluid, such as air, passes to facilitate attenuation of the filament-forming composition into a fibre as it exits the fibre-forming hole.

The filament-forming composition may be spun into one or more fibres by any suitable spinning process, such as meltblowing, spunbonding, electro-spinning, and/or rotary spinning. The filament-forming composition may be spun into a plurality of fibres by meltblowing. For example, the filament-forming composition may be pumped from a tank to a meltblown spinnerette. Upon exiting one or more of the fibre-forming holes in the spinnerette, the filament-forming composition is attenuated with air to create one or more fibres. The fibres may then be dried to remove any remaining solvent used for spinning, such as the water.

The fibres may be collected on a belt, such as a patterned belt to form a fibrous non-woven sheet comprising the fibres.

Preferably, fibrous nonwoven sheets are made by bonding or interlocking fibers by mechanical, thermal, chemical, or solvent means. When fibrous nonwoven sheets are made from staple fibers, their production involves the formation of a uniform web by a wet-laid process or carding, followed by bonding the nonwovens either thermally or by other means such as needle punching, hydroentangling, etc. Spun-laid fibrous nonwovens are made in one continuous process where fibers are spun and then directly dispersed into a web by deflectors or air streams. Meltblown fibrous nonwoven is a one-step process in which high-velocity air blows a molten thermoplastic resin from an extruder die tip on to a conveyor or take-up screen to form a fine fibrous and self-bonded web.

Granular Detergent Composition

The granular detergent composition comprises a first plurality of particles. Typically, the granular detergent composition is a fully formulated detergent composition, not a portion thereof such as a spray-dried or agglomerated particle that only forms part of the detergent composition.

The granular detergent composition can be any suitable granular detergent composition. The granular detergent composition may be a laundry composition, a hard surface cleaner, a dish washing composition, a toilet cleaner or a mixture thereof.

Preferably, the first plurality of particles comprises blown powder particles, agglomerated particles, extruded particles, enzyme prills or a mixture thereof.

Typically, the granular detergent composition comprises a plurality of chemically different particles, such as spray-dried base detergent particles and/or agglomerated base detergent particles and/or extruded base detergent particles, in combination with one or more, typically two or more, or three or more, or four or more, or five or more, or six or more, or even ten or more particles selected from: surfactant particles, including surfactant agglomerates, surfactant extrudates, surfactant needles, surfactant noodles, surfactant flakes; polymer particles such as cellulosic polymer particles, polyester particles, polyamine particles, terephthalate polymer particles, polyethylene glycol polymer particles; builder particles, such as sodium carbonate and sodium silicate co-builder particles, phosphate particles, zeolite particles, silicate salt particles, carbonate salt particles; filler particles such as sulphate salt particles; dye transfer inhibitor particles; dye fixative particles; bleach particles, such as percarbonate particles, especially coated percarbonate particles, such as percarbonate coated with carbonate salt, sulphate salt, silicate salt, borosilicate salt, or any combination thereof, perborate particles, bleach catalyst particles such as transition metal bleach catalyst particles, or oxaziridinium-based bleach catalyst particles, pre-formed peracid particles, especially coated pre-formed peracid particles, and co-bleach particles of bleach activator, source of hydrogen peroxide and optionally bleach catalyst; bleach activator particles such as oxybenzene sulphonate bleach activator particles and tetra acetyl ethylene diamine bleach activator particles; chelant particles such as chelant agglomerates; hueing dye particles; brightener particles; enzyme particles such as protease prills, lipase prills, cellulase prills, amylase prills, mannanase prills, pectate lyase prills, xyloglucanase prills, bleaching enzyme prills, cutinase prills and co-prills of any of these enzymes; clay particles such as montmorillonite particles or particles of clay and silicone; flocculant particles such as polyethylene oxide particles; wax particles such as wax agglomerates; perfume particles such as perfume microcapsules, especially melamine formaldehyde-based perfume microcapsules, starch encapsulated perfume accord particles, and pro-perfume particles such as Schiff base reaction product particles; aesthetic particles such as coloured noodles or needles or lamellae particles, and soap rings including coloured soap rings; and any combination thereof.

The granular laundry detergent composition typically comprises detergent ingredients. Suitable detergent ingredients include: detersive surfactants including anionic detersive surfactants, non-ionic detersive surfactants, cationic detersive surfactants, zwitterionic detersive surfactants, amphoteric detersive surfactants, and any combination thereof; polymers including carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof; builders including zeolites, phosphates, citrate, and any combination thereof; buffers and alkalinity sources including carbonate salts and/or silicate salts; fillers including sulphate salts and bio-filler materials; bleach including bleach activators, sources of available oxygen, pre-formed peracids, bleach catalysts, reducing bleach, and any combination thereof; chelants; photobleach; hueing agents; brighteners; enzymes including proteases, amylases, cellulases, lipases, xylogucanases, pectate lyases, mannanases, bleaching enzymes, cutinases, and any combination thereof; fabric softeners including clay, silicones, quaternary ammonium fabric-softening agents, and any combination thereof; flocculants such as polyethylene oxide; perfume including starch encapsulated perfume accords, perfume microcapsules, perfume loaded zeolites, schif base reaction products of ketone perfume raw materials and polyamines, blooming perfumes, and any combination thereof; aesthetics including soap rings, lamellar aesthetic particles, geltin beads, carbonate and/or sulphate salt speckles, coloured clay, and any combination thereof: and any combination thereof.

Suitable detersive surfactants include anionic detersive surfactants, non-ionic detersive surfactant, cationic detersive surfactants, zwitterionic detersive surfactants, amphoteric detersive surfactants, and any combination thereof.

Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof.

The composition may contain mixtures of different types of conditioning actives. The compositions of the present disclosure may contain a certain conditioning active but be substantially free of others. For example, the composition may be free of quaternary ammonium ester compounds, silicones, or both. The composition may comprise quaternary ammonium ester compounds but be substantially free of silicone. The composition may comprise silicone but be substantially free of quaternary ammonium ester compounds.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

Evaluation of 3 different polyvinyl alcohol sheet materials has been conducted across 4 key making parameters. Evaluation made using Masipack Ultra Multi Lane with F105 forming collar and forming tube, trial completed according to following settings:

| Parameter | Setting |
|---|---|
| Speed | 70 bags per minute |
| On time | 7s |
| Delay | 0.8s |
| Delay horizontal jaw | 0.5s |
| Horizontal sealing time | 0.37s |
| Sealing torque | 85% |
| Horizontal cooling | 0.6 |
| Delay vertical jaw | 0.13s |
| Vertical jaw sealing time | 0.3s |
| Film traction delay | 0.15s |
| Film traction on time | 0.33s |
| Vertical seal temp | 271c |

The parameters tested were;
Parameter 1: Sheet un-winding—Evaluation of ability to unroll sheet from storage roll and to maintain sheet roll in correct un-winding location
Parameter 2: Sheet sticking at forming shoulder—Evaluation of ability to successfully align film and create robust vertical seal
Parameter 3: Sheet bunching at forming tube—Evaluation of process reliability and ability to successfully make unit dose articles for given time window
Parameter 4: Sheet shrinkage—Evaluation of unit dose articles being made per length of sheet

Sheet Materials:

TABLE 1

| | | |
|---|---|---|
| 1 | Casted sheet 1 | L0832 PVA film (Foshan |
| | | Polyva Materials Co., Ltd). |
| 2 | Nonwoven | 0% gel-breaker |
| | sheet 1 | PvOH homopolymer, 100-120 kDa, |
| | | degree of hydrolysis 86-89% |
| 3 | Nonwoven | 5 wt % PEG600 gel-breaker |
| | sheet 2 | PvOH homopolymer, 100-120 kDa, |
| | | degree of hydrolysis 86-89% |

For Nonwoven sheets, PVOH fibres were converted into nonwoven sheet by JIANGSU WISDOM NONWOVEN CO. LTD, Address: No. 19 RenMinDong Road, Wu Jin, Changzhou, Jiangsu, China.

Test Protocol (Parameters 1-3):
Machine set to above described parameters
Sheet of interest loaded on to Multi lane unwinding station and passed through default web pathway
Multi lane initiated and evaluations made
Note—manual intervention required to maintain casted film (sheet 1) in un-winding location to enable parameters 2-4 to be evaluated
Note horizontal sealing jaw not operated

Test Protocol (Parameters 4):
Protocol as per above description with inclusion of sheet marking step prior to sheet loading

Sheet Marking Protocol
11 meters of sheet unwound
Marking perpendicular to sheet pathway made upon sheet 8 meters from start of roll
Marking perpendicular to sheet pathway made 2 meters from initial marking (at 10 meters from roll start)
Roll re-wound and loaded to multi lane equipment
Sheet passed through multi lane operation with vertical sealing
Distance between 8 m and 10 m markings evaluated to determine shrinkage

Test Results:

Parameter 1;

Table 2 below summarizes the sheet un-winding data with evaluation on ability to maintain sheet roll in correct un-winding location. From the data it can clearly be seen that non-woven sheets 1 and 2 provide superior sheet un-winding compared to a casted sheet 1

TABLE 2

| | Occurrence | Ability to | |
|---|---|---|---|
| | of sheet | maintain | |
| | adhesion to | sheet roll in | |
| | main roll | correct un- | |
| | during un- | winding | |
| Film | winding? | location? | Observations |
| Casted | Yes | No | Roll pulled from |
| sheet 1 | | | location due to |
| | | | sheet to roll |
| | | | adhesion |
| Non-woven | No | Yes | Roll maintained in |
| sheet 1 | | | correct location |
| Non-woven | No | Yes | Roll maintained in |
| sheet 2 | | | correct location |

Parameter 2;

Table 3 summarizes the evaluation of sheet sticking at the forming shoulder and subsequent ability to successfully align sheet to create a robust vertical seal. From the data it can clearly be seen that non-woven sheets 1 provides lower sheet sticking at the forming shoulder and subsequently superior sheet overlap and ability to form a robust vertical seal compared to casted sheet 1. In most instances, robust seals were not achieved when using casted sheet 1. Overall, it was not possible to set up a production run using casted sheet 1 in which a robust vertical seal could be repeatably achieved.

TABLE 3

| | | Ability to | | Time from |
|---|---|---|---|---|
| | Occurrence | successfully | | baseline |
| | of | align | Ability to | machine |
| | sheet | sheet | create | set up to |
| | sticking | overlap | robust | successful |
| | at forming | to create | vertical | vertical |
| | shoulder | vertical seal | seal | seal creation |
| Casted | Yes | No (small | No (small | Unsuccessful |
| sheet 1 | | number | number of | |
| | | of successful | robust | |
| | | alignments | seals | |
| | | achieved) | achieved) | |
| Non- | No | Yes | Yes | 15 mins |
| woven | | | | |
| sheet 1 | | | | |

Parameter 3;

Table 4 summarizes the evaluation of sheet bunching during manufacture. From the data it can clearly be seen that non-woven sheet 1 provided lower sheet bunching at the forming tube compared to casted sheet 1. Due to the lack of success in making the unit dose articles using the casted sheet 1, the planned production was ceased early.

TABLE 4

| | Occurrence | Evaluation of Process Reliability | | |
|---|---|---|---|---|
| | of | | | Number of |
| | sheet | Utilization | Utilization | unit dose |
| | bunching | of 15 min | of 45 min | articles made |
| | at forming | planned set | planned | relative to |
| | tube | up time | run time | 3150 target |
| Casted | Yes | >60 min | Less than | Less than 10 |
| sheet 1 | | (failure) | 10% | |
| Non- | No | 15 min | 100% | 3150 |
| woven | | | | |
| sheet 1 | | | | |

Parameter 4;

Table 5 summarizes the evaluation of sheet shrinkage and the resulting ability to create unit dose articles per length of sheet. From the data it can clearly be seen non-woven sheet 1 provides lower sheet shrinkage during the creation of the vertical seal and subsequently enables additional unit dose articles to be formed per length of sheet compared to casted sheet 1.

| | Marked | Marked | | |
|---|---|---|---|---|
| | distance prior | distance | Change | |
| | to vertical | after | in | |
| | seal | vertical seal | sheet | Percentage |
| | creation | creation | length | length |
| | (mm) | (mm) | (mm) | loss |
| Casted sheet 1 | 1400 | 1363 | −37 | 2.64% |
| Non-woven | 1398 | 1386 | −12 | 0.86% |
| sheet 1 | | | | |

### SUMMARY

As can be seen from the above data, it is the specific choice of sheet material in combination with the steps in the present process that addresses the problem and provides for an efficient and effective process for making water-soluble unit dose articles.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of making a water-soluble detergent unit dose article comprising the steps of
a. providing a water-soluble non-woven fibrous sheet on a roll;
b. unwinding the water-soluble non-woven fibrous sheet in a machine direction from the roll via at least a first intermediate roll;
c. feeding the water-soluble non-woven fibrous sheet from the at least one intermediate roll via a forming unit to shape the water-soluble non-woven fibrous sheet into a tube shape;
d. sealing the water-soluble non-woven fibrous sheet via a machine direction seal, a cross-direction seal or a mixture thereof to create a container having an open end;
e. filling the open container with a water-soluble granular detergent composition;
f. sealing the second open end via a machine direction seal, a cross-direction seal or a mixture thereof to form a closed water-soluble unit dose article;
g. transferring the water-soluble unit dose article onto a moving conveyer;
h. transporting the water-soluble unit dose article from the moving conveyer into a packaging container.

2. The process according to claim 1, wherein the non-woven fibrous sheet comprises polyvinyl alcohol.

3. The process according to claim 2, wherein the polyvinyl alcohol is a polyvinyl alcohol homopolymer.

4. The process according to claim 3, wherein the polyvinyl alcohol homopolymer has an average percentage degree of hydrolysis of from about 75% to about 100%.

5. The process according to claim 3, wherein the polyvinyl alcohol homopolymer has an average viscosity of from about 1 to about 65 mPas, wherein the viscosity is measured as a about 4% aqueous solution in demineralized water at about 20° C.

6. The process according to claim 1, wherein in steps d and f, each machine direction seal, cross direction seal or mixture thereof is independently sealed via heat sealing, solvent sealing, pressure sealing, ultrasonic sealing or a mixture thereof.

7. The process according to claim 5, wherein the machine direction are achieved using a machine direction sealing unit, wherein the machine direction sealing unit is a static seal unit or a reciprocating seal unit and wherein the cross direction seals are achieved using a cross direction sealing unit, wherein the cross direction sealing unit is a static seal unit or a reciprocating seal unit.

8. The process according to claim 1, wherein the forming unit comprises belts to pull the non-woven fibrous sheet in a machine direction during forming of the container.

9. The process according to claim 1, wherein, the environmental conditions from step d onwards are a temperature of between about 20° C. and about 30° C. and a relative humidity of between about 50% and about 95%, and wherein the environmental conditions are the conditions immediately surrounding the water-soluble unit dose article.

10. The process according to claim 1, wherein the forming unit comprises a forming shoulder wherein the non-woven fibrous sheet has a first edge and a second edge, and as the non-woven fibrous sheet passes over the forming shoulder the first edge and second edge are brought into proximity of one another.

11. The process according to claim 1, wherein the conveyer is a continuously moving surface.

12. The process according to claim 1, wherein the conveyer comprises a means to transfer a determined plurality of water-soluble unit dose articles to the container.

13. The process according to claim 1, wherein the at least first intermediate roll can be a tension arm, a transfer roll or a mixture thereof.

14. The process according to claim 1, wherein the non-woven fibrous sheet comprises a plurality of fibers, wherein the fibers comprise polyvinyl alcohol.

15. The process according to claim 14 or wherein the fibrous sheet has a basis weight of between about 15 gsm and about 60 gsm.

16. The process according to claim 1, wherein no lubricating coating is applied to the exterior surface of the unit dose article.

17. The process according to claim 16, wherein the lubricating coating is selected from silica, talc, zeolite or a mixture thereof.

18. The process according to claim 1, wherein the packaging container can be made from plastic, metal, paper-based material or a mixture thereof.
